(19) United States
(12) Patent Application Publication
(10) Pub. No.: US 2015/0271567 A1
(43) Pub. Date: Sep. 24, 2015

(54) 3D VIDEO WARNING MODULE

(71) Applicant: TELEFONAKTIEBOLAGET L M ERICSSON (PUBL), Stockholm (SE)

(72) Inventors: Julien Michot, Sundbyberg (SE); Ivana Girdzijauskas, Solna (SE); Thomas Rusert, Stockholm (SE)

(73) Assignee: TELEFONAKTIEBOLAGET L M ERICSSON (PUBL), Stockholm (SE)

(21) Appl. No.: 14/439,567

(22) PCT Filed: Oct. 29, 2012
(86) PCT No.: PCT/EP2012/071397

§ 371 Date: Apr. 29, 2015

(51) Int. Cl. H04N 21/488; H04N 21/431; H04N 13/04; H04N 13/00; H04N 13/02

(52) U.S. Cl. CPC H04N 21/4882; H04N 13/0022; H04N 13/0025; H04N 13/0051; H04N 13/0055; H04N 13/0059; H04N 13/0066; H04N 13/0239; H04N 13/0296; H04N 13/04; H04N 21/4312

(57) ABSTRACT

There is provided a 3D video warning module comprising an input, a processor, and an output. The input is for receiving: capture information from a 3D capture device, and display information from at least one 3D display device, wherein the 3D display device is for displaying 3D video captured by the 3D capture device. The processor is for analyzing the capture information and the display information, the processor arranged to identify at least one issue (an incompatibility). The output is for sending a notification of the issue to at least one of the 3D capture device and the 3D display device.

### TECHNICAL FIELD

The present application relates to a 3D video warning module, a 3D capture device, a 3D display device, a method for detecting an issue in a 3D video system, and a computer-readable medium.

### BACKGROUND

The whole concept of 3D video is based on tricking the human visual system to perceive depth by showing the left and right images on a 2D surface, which is inherently different from what happens when we observe the 3D space in a natural way. When observing a stereoscopic display, our eyes converge to the point where an object appears to be, whereas our eyes focus on the display where the image actually is. This does not happen when we observe a real 3D space and, if not done appropriately, leads to confusion and subsequent eye strain and fatigue. Many other issues in production and displaying of 3D content are known, the most important being listed below. However, many factors that affect the 3D quality are yet to be discovered and understood.

Some issues that may occur when generating and displaying 3D content are:
Divergence: the disparity (distance in pixels between the left and right images) is too big;
Too much convergence: the disparity is too big (and negative)
Framing issue (the part of the scene popping out of the screen (negative disparity) will be cut at the boundary in one view)
Cardoard/puppet theater effect: the rendered scene has an unnatural scale (too small, too deep)
Chromatic differences: the two images have slightly different colors
Geometric distortions: for instance when the two views are vertically misaligned
Focus mismatch
Field of view mismatch
Temporal synchronization: the two images do not correspond to the same moment in time making the moving part of the scene unsynchronized.

Good 3D video production is a difficult task due to many specific issues that come up when one wants to display 3D content on a 3D enabled display. For instance, one has to ensure that the maximum positive disparity (distance in pixels between the left and right view) is below a certain limit (depending on the pixel width and viewing distance) in order to prevent the viewer's eyes from diverging. Also, one has to avoid high negative disparities for a long period of time that make the viewer go excessively cross-eyed, causing eye strain. Another issue is known as the “framing issue” and appears when an object has a negative disparity and is located close to the image left or right boundary. Other typical problems are view mismatch (focus mismatch, field of view mismatch, geometrical misalignment), color mismatch, lack of temporal synchronization etc.

In real-time 3D video conferencing setups, there is either no detection and adaptation of the 3D imaging, or it is up to the transmitting user to manually adapt the 3D camera and scene settings to improve the 3D experience of the receiving user based on human instruction. For instance, the receiving user will ask the transmitting user (by voice, text or other form of communication) to shift the camera sensors. However, this requires either user to understand some principles of stereography. In the likely event that a user of the system is naïve and does not know how to fix the issue, he will just have a bad 3D experience.

In the case where there are many receivers with 3D displays each receiving the same 3D video, the 3D content has to be adapted in order to be well rendered in all end points.

The article: “Immersive Multi-User 3D Video Communication” by Feldmann, Ingo, Schreer, Oliver, Schafer, Raff, Fei, Zuo, Belt, Harm and Divorra Escoda, Oscar (2009), Proc. of International Broadcast Conference (IBC 2009), Amsterdam, Netherlands, September 2009 summarizes first results and experiences of the European FP7 research project 3D Presence which aims to build a three party and multi-user 3D teleconferencing system. The authors use both 2D and 3D autostereoscopic screens for 3D video conferencing. The described system is supposed to be well positioned or calibrated and in this way does not require parameters to be adjusted (camera or scene). Calibration of the system parameters must be performed manually.

“Production Rules for Stereo Acquisition” Frederik Zilly, Josef Kluger, and Peter Kauff, Proceedings of the IEEE Vol, 99, No. 4, April 2011, proposes a stereo analyzer system. In this system, a display shows in real-time the current disparity histogram of the scene and alerts when there is a possible framing violation or too much disparity. This device helps the stereographer to check if the scene will be well experienced in the targeted screen configuration. This requires the stereographer to input the system limits for the available warnings. These system limits are based on the targeted viewing conditions of one generic or hypothetical display.

International patent application number PCT/EP2011/069942 “Receiver-side adjustment of stereo and 3D-video” by Andrey Norkin and Ivana Girdzijauskas, it is shown how to adapt the rendering parameters to a different screen size and/or viewer distance while maintaining the relative depth perception.

### SUMMARY

The described 3D warning system provides a solution to 3D quality monitoring in the case where many different 3D screens could be used in the 3D system and on-the-fly adaptation to changing viewing conditions is desired. Further, the described system supports both depth plus image cameras and stereo cameras.

Accordingly, there is provided a 3D video warning module comprising: an input, a processor and an output. The input is for receiving: capture information from a 3D capture device, and display information from at least one 3D display device, wherein the 3D display device is for displaying 3D video captured by the 3D capture device. The processor is for analyzing the capture information and the display information, the processor arranged to identify at least one issue. The output is for sending a notification of the issue to at least one of the 3D capture device and the 3D display device.

By receiving both capture information and display information, the 3D video warning module can identify an issue arising between the 3D capture device that captures 3D video and the 3D display device arranged to display the 3D video. The issue may be a problem. The issue may be a problem with the 3D effect presented by the 3D display device. When an issue is identified a notification is sent to either or both of the 3D capture device or the 3D display device. The issue may be an incompatibility between the 3D capture device and the 3D display device. The issue may be an incompatibility between the respective setups of the 3D capture device and the 3D display device.

The 3D capture device may be a stereo camera or an image plus depth camera. The at least one 3D display device may be arranged to display 3D video captured by the 3D capture device.

The notification of the issue sent to the 3D capture device may comprise modified capture parameters in order to resolve the issue. The modified capture parameters may be generated by the processor. Where the 3D video captured by the capture device is sent to a plurality of 3D display devices, the modified capture parameters may be chosen to create 3D video suitable for each of the plurality of 3D display devices.

The notification sent to the 3D display device may be a warning of an issue. If the incompatibility warning is not retracted within a predetermined period of time, the 3D display device may switch to a 2D video mode.

The input may also be for receiving 3D video captured by the 3D capture device; and the processor may be for analyzing the 3D video.

The capture information may comprise at least one of: sensor width, sensor resolution, focal length, sensor shift, baseline, encoding parameters, and depth range. The display information may comprise at least one of: screen width, screen resolution, image shift, baseline, focal length, viewer position, inter-ocular distance, and number of viewers.

The identified at least one issue may comprise at least one of: maximum disparity threshold exceeded; minimum disparity threshold exceeded; a framing issue; incorrect scale; chromatic difference; geometric distortion; and/or lack of synchronization. How each of the above issues may be addressed is described herein.

The 3D video warning module may be located at: a location for the transmission of 3D video; a location for the distribution of 3D video; a location for the reception of 3D video; or a location for the reception and transmission of 3D video.

There is further provided a 3D capture device incorporating a 3D video warning module as described herein. There is further provided a 3D display device incorporating a 3D video warning module as described herein.

There is further provided a method for detecting an issue in a 3D video system, the method comprising receiving capture information from a 3D capture device, and display information from at least one 3D display device, wherein the 3D display device is arranged to display 3D video captured by the 3D capture device. The method further comprises: analyzing the capture information and the display information and determining if these cause at least one issue; and if an issue is detected, sending a notification of the issue to at least one of the 3D capture device and the 3D display device.

By receiving both capture information and display information, an issue may be identified, the issue arising between the 3D capture device that captures 3D video and the 3D display device arranged to display the 3D video. The issue may be a problem. The issue may be a problem with the 3D effect presented by the 3D display device. When an issue is identified a notification is sent to either or both of the 3D capture device or the 3D display device. The issue may be an incompatibility between the 3D capture device and the 3D display device. The issue may be an incompatibility between the respective setups of the 3D capture device and the 3D display device.

The notification of the issue sent to the 3D capture device may comprise modified capture parameters in order to resolve the issue. Where the 3D video captured by the capture device is sent to a plurality of 3D display devices, the modified capture parameters may be chosen to create 3D video suitable for each of the plurality of 3D display devices.

The notification sent to the 3D display device is a warning of an issue. If the incompatibility warning is not retracted within a predetermined period of time, the 3D display device may switch to a 2D video mode. The 3D video may be also analyzed for the detection of issues.

The capture information may comprise at least one of: sensor width, sensor resolution, focal length, sensor shift, baseline, encoding parameters, and depth range. The display information may comprise at least one of: screen width, screen resolution, image shift, baseline, focal length, viewer position, inter-ocular distance, and number of viewers.

There is further provided a computer-readable medium, carrying instructions, which, when executed by computer logic, causes said computer logic to carry out any of the methods defined herein. There is further still provided a computer-readable storage medium, storing instructions, which, when executed by computer logic, causes said computer logic to carry out any of the methods defined herein. The computer program product may be in the form of a non-volatile memory or volatile memory, e.g. an EEPROM (Electrically Erasable Programmable Read-only Memory), a flash memory, a disk drive or a RAM (Random-access memory).

### BRIEF DESCRIPTION OF THE DRAWINGS

A 3D video warning module will now be described, by way of example only, with reference to the accompanying drawings, in which:

FIG. 1 shows a typical arrangement for a stereo camera;

FIG. 2 shows a common setup of a 3D stereo display;

FIG. 3 illustrates a 3D video warning module;

FIG. 4 illustrates a system within which the 3D warning module may operate;

FIG. 5 illustrates a method for improving the quality of 3D video;

FIG. 6 illustrates a framing issue;

FIG. 7 illustrates an approximation of the viewing setup in FIG. 6;

FIG. 8 illustrates a 3D warning module as applied to a stereo camera; and

FIG. 9 illustrates a 3D warning module as applied to a depth plus image camera.

### DETAILED DESCRIPTION

Described herein are methods and apparatus for informing the sender about the receiver(s) 3D experience quality based on information about the receiver(s) display setups and the viewers' viewing positions.

After receiving this information, the sender may adjust its 3D capture settings (e.g. camera configuration or scene setup, such as distance of the scene from the camera) to improve the 3D experience quality of the viewers. The adjustment of 3D capture settings can be done (a) by purely automatic means, i.e. without intervention of a human operator, or (b) with intervention of a human operator at the sender side.

In case of option (b), the system indicates potential problems with the 3D capture settings and suggests modifications to improve the situation. While option (a) is generally preferable from a usability point of view, some 3D capture parameters (such as physical camera position or orientation, or scene setup) may not be easily automatically configurable, and thus it is appropriate to give the user instructions. In both instances, there is a technical effect in identifying a conflict between 3D capture parameters and 3D display parameters for a respective 3D camera and 3D display, the conflict creating an inappropriate 3D experience, which may cause discomfort or confusion for a viewer.

By way of example, if a severe issue is detected in the 3D video content that would lead to viewer discomfort on the particular 3D display, then the system disables 3D video and falls back to 2D mode.

To put the disclosure into context, a short explanation of 3D camera and display geometry follows.

To explain the relationship between the camera capturing parameters, the embodiments described herein focus on a stereo camera setup. However, it will be apparent to one skilled in the art that a similar principle applies to the cases of multiple camera setups, and depth camera plus image camera setups.

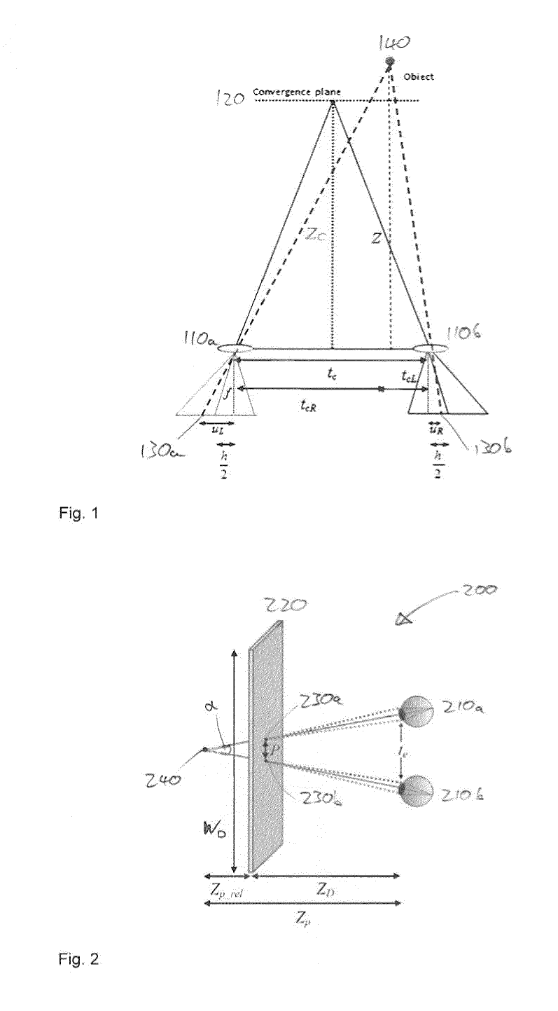

FIG. 1 shows a typical arrangement for a stereo camera 110, the so-called parallel sensor-shifted setup, where here the convergence of cameras 110a, 110b is established by a small shift of the sensor targets, by h/2. This setup turns out to provide better stereoscopic quality than the toed-in setup where the two cameras of the stereo camera would be inward-rotated until the convergence is set, as was widely used in practice. Let f be the camera focal length, t_{c} the baseline distance (the distance between the camera centers) and Z_{C} the distance to the convergence plane 120. Suppose a captured object 140 is on the distance (depth) Z from the cameras. The object 140 is captured at a different point (130a, 130b) of the image plane for each camera 110a, 110b of the stereo camera 110, due to the different arrangements of the cameras 110a, 110b. The distance between the image points for the object 130 as captured at the image plane for each camera 110a, 110b is called the disparity d. Following the above notation, we can write the following expression for disparity,

$$d = h - \frac{{t}_{c} f}{Z} = {t}_{c} f ( \frac{1}{{Z}_{C}} - \frac{1}{Z} ) \qquad ( 1 )$$

An object at the convergence distance Z_{C} and captured by the stereo camera 110 will have zero disparity. From equation (1) we see that in this case:

$$h = \frac{{t}_{c} f}{{Z}_{c}} .$$

Briefly considering the depth camera case, let v be the quantized depth map value corresponding to a real depth distance Z between an object and a camera. In this case:

$$Z = \frac{1}{\frac{v}{{2}^{n}} ( \frac{1}{{Z}_{near}} - \frac{1}{{Z}_{far}} ) + \frac{1}{{Z}_{far}}} \qquad ( 2 )$$

where n is the number of bits used to quantize v, Zₙₑₐᵣ and Z_{far} correspond to the nearest and farthest clipping planes from the original 3D space respectively. Where a 3D scene is captured by a depth camera and an image camera, a stereo display must generate a second view based on a depth map (from the depth camera) and a texture map (derived from the image camera). Here, the disparity d_{d} corresponds to a depth value Z (for the 1D case) as follows:

$${d}_{d} = s - \frac{{bf}_{d}}{Z} \qquad ( 3 )$$

where f_{d} is the focal length of the rendered view. Often the focal length fₐ is equals to the camera focal length of the image camera, so f_{d}=f. The variables b and s are the view baseline distance and image shift respectively.

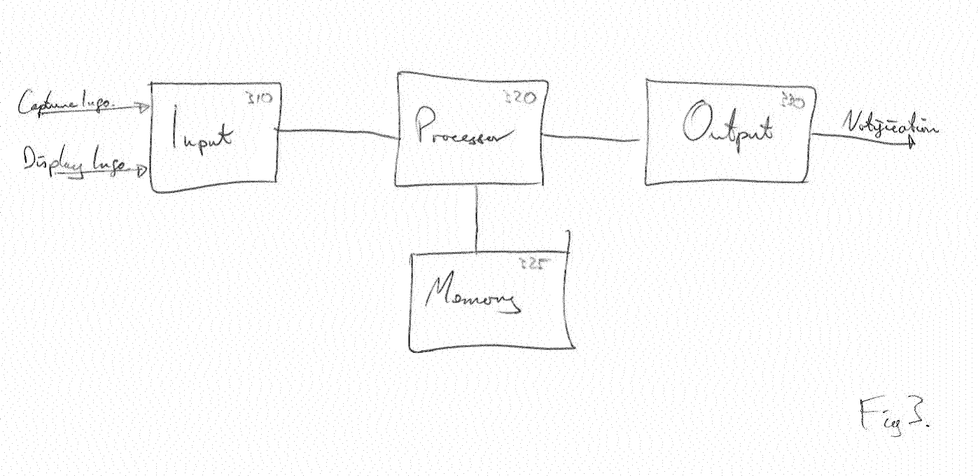

FIG. 2 shows a common setup of a 3D stereo display. The principles described below apply equally multiview displays, but for clarity, a stereo display is used as an example. The display 200 comprises a screen 220 which includes a mechanism for displaying a different image to each eye 210a, 210 b of a viewer. Such a mechanism may comprise the use of polarization filters on the screen and glasses for the viewer, or a shutter array. The mechanism allows an image point to be displayed on the screen at different locations 230a, 230b for each eye. The separation of the respective image points 230a, 230b, gives the impression of depth such that the image point may appear at a depth location 240 at a depth different to the screen distance.

The distance between the viewer's eyes 210 (the so-called inter-ocular distance) is tₑ. Assume that the viewer sits at a distance Z_{D} from the screen. Basic geometry gives us the following expression for the perceived depth Z_{P}:

$${Z}_{p} = \frac{{Z}_{D} {t}_{e}}{{t}_{e} - P} \qquad ( 4 )$$

The relative perceived depth Z_{P rel}, is given by:

$${Z}_{{p}_{rel}} = \frac{{Z}_{D} P}{{t}_{e} - P} \qquad ( 5 )$$

where P is the screen parallax (or on screen disparity) and corresponds to:

P=dS_{M} (6).

In certain circumstances a post image shift is performed, denoted by distance s, and the total image separation distance is d+s, so: P=(d+s)S_{M}.

In the expression above,

$${S}_{M} = \frac{{W}_{d}}{{W}_{s}}$$

is known as the magnification factor (when the video is displayed in full screen) and W_{d} and Wₛ are respectively the display width and the sensor width. If the video is not displayed in full screen, the magnification factor is

$${S}_{M} = \frac{{W}_{d}}{{W}_{s}} \frac{{W}_{d}}{{W}_{d}^{px}}$$

where W_{d}^{px} is the width resolution (in pixels) and w_{d}^{px} the width (in pixels) of the displayed video on the screen. s is the eventual image shift performed when the two views are displayed on the stereo screen.

Where the 3D camera is a stereo camera, it is necessary to estimate the disparity map between the two views. There are numerous options available to achieve this, for instance by detecting features in both images and matching them against each other and identifying the difference in their relative position on screen. Another way is to employ a so called optical flow in several areas of the two images.

The disparities or depths in the system are calculated in pixels or some other relative scale. It is necessary to define the limits for disparity or depth in the context of a particular display and inter-ocular distance for either a generic user or the particular user. This requires the conversion of disparity or depth limits to a physical scale for the particular display. Alternatively, the inter-ocular distance tₑ can be converted to the relevant relative scale, such as pixels, to enable the calculation of disparity or depth limits in that relative scale.

For example, once the disparities (in pixels) are known and in the case the system has identified the limits Pₘᵢₙ/Pₘₐₓ, these may be converted to a physical distance (using the physical size of the pixels) in order to identify whether the disparity exceeds the interocular distance tₑ (eq. 6). Alternatively, in the case the system has identified limits directly on the disparities (pₘᵢₙ/pₘₐₓ), the system may then check if all disparities are in the range [pₘᵢₙ, pₘₐₓ]. The latter may equivalently be performed in the case of image (2D) plus depth (Z) video, where the system identifies limits on the depth (Zₘᵢₙ, Zₘₐₓ) and the system may then check if all depths are in the range [Zₘᵢₙ, Z^{max}].

FIG. 3 illustrates a 3D video warning module as presented herein. The 3D video warning module comprises an input 310, a processor 320, a memory 325, and an output 330. The input 310 receives: capture information from a 3D capture device, and display information from at least one 3D display device. The 3D display device is arranged to display 3D video captured by the 3D capture device. The processor 320 is arranged to analyze the capture information and the display information, and to identify at least one incompatibility. The output 330 is arranged to send a notification of the incompatibility to at least one of the 3D capture device and the 3D display device. The processor 320 is arranged to receive instructions which, when executed, causes the processor 320 to carry out the methods described herein. The instructions may be stored on the memory 325.

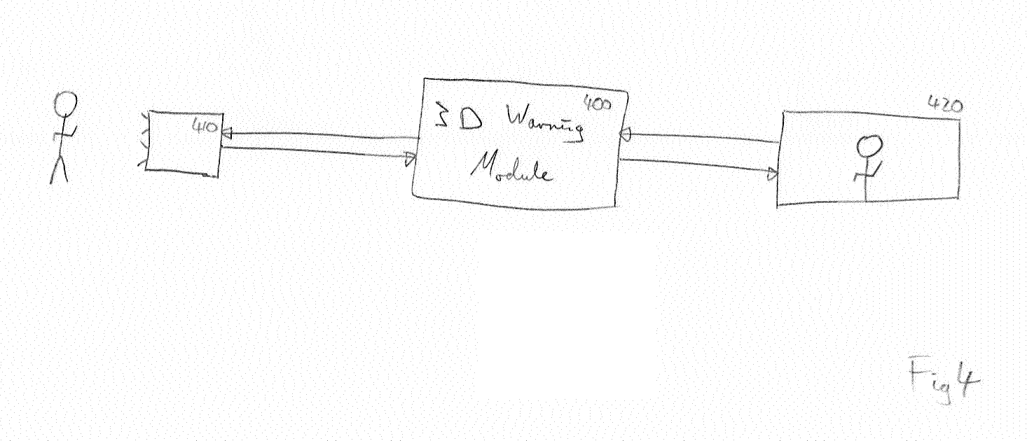

FIG. 4 illustrates a system within which the 3D warning module may operate. A camera 410 sends 3D video via the 3D warning module 400 to a 3D display 420. The 3D warning module 400 may be located at the transmitting end, associated to the camera 410, or at the receiving end, associated with the display 420. Further, the 3D warning module may be associated with a communications hub within the transmission network between the camera 410 and the display 420. Multiple displays 420 at different locations may receive a 3D video feed from camera 410. At each location there may be both a 3D camera and a 3D display 420, the display arranged to show the 3D video captured by 3D cameras at any of the connected sites.

The 3D warning module is able to identify the at least one incompatibility between a 3D camera 410 and a 3D display 420. The incompatibility detection is based on at least one of the following inputs.
3D video. Some examples of detectable issues are: geometric distortions (e.g., vertical misalignment), focus mismatch, field of view mismatch, loss of temporal synchronization of the two (or more) video views etc., or excessive positive or negative disparities between the video views.
Parameters and scene geometry at the transmitting location (camera end), such as baseline distance, sensor shift, room geometry, depth range, lighting conditions etc.
Viewing conditions and comfort zone(s) at the receiving end(s): viewing distance, screen width etc.
Parameters that can be adjusted at the transmitting end (e.g., camera position, sensor shift, camera focal length (zoom), objects to be in a scene etc.)
A list of parameters and actions that can be performed at the receiver(s') side(s) such as: ability to perform view synthesis, changing disparity in order to move the scene forward or backwards, switching to 2D mode etc.

The 3D warning module may further comprise the functionality of enhancing the 3D video experience of a viewer by way of a 3D enhancer function or module. This may be done once an incompatibility has been detected by an issue detector function or module. The enhancing may be performed by: modifying the 3D video stream feed; changing at least one 3D scene capture parameter; changing at least one 3D display parameter. A parameter may be changed automatically by hardware and/or software. A parameter may also be changed by sending an instruction to a user of the camera or display. At an incompatibility detection step, the type and origin of an incompatibility may be identified. These are then used to determine how to enhance the 3D video.

The 3D warning module undertakes a specific action when an incompatibility is detected. An action can be in the form of a message or request, both of which can be sent to either the sender or the receiver(s).

Some examples of messages are:
A message to the sender such as: “Disparity too high, shift the sensor shift to the left” or “Framing issue: move this object to the left” etc., where the meaning “this object” would be further specified in the message, e.g. by marking the object in an image
A message to the receiver(s), for instance: “Disparity too high, switching to 2D” or “Framing issue on the left, cutting left part” or “Warning: disparity too high”. The message can also be in a form “You are sitting very close to the display. Move backwards.”
Regions in images where the issue is detected may also be marked (e.g., object(s) with negative disparity, or object that create a framing problem etc.)

Some examples of requests are:
Ask the sender to improve the 3D video, for instance by calibrating it,

changing the sensor shift or correcting some parameters such as focal length etc.
Send an advised baseline to the receiver in order to help the renderer (DIBR) of a stereo or multi-view display. We can also send an image shift value adapted to the receiver's screen.
Ask the receiver to adjust its viewing conditions by himself, for instance by changing the depth range or sensor shift of the DIBR or by moving closer to the screen.

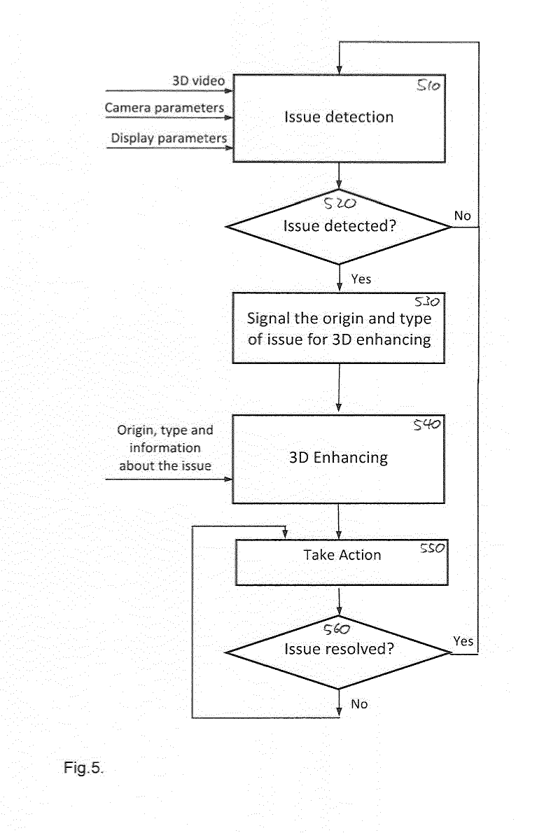

FIG. 5 illustrates a method for improving the quality of 3D video. The method begins with issue detection 510 performed using 3D video, camera parameters and display parameters. Issue detection 510 comprises analysis of the received variables to identify problems with the perceived 3D effect at the at least one display apparatus. At 520 a determination is made as to whether or not an issue is detected. If no issue is detected issue detection monitoring is continued at 510. If an issue is detected at 520, then the process proceeds to 530 where a signal indicating the origin and type of issue is sent to the 3D enhancing at 540. At 540, corrective measures are taken to address the detected issue. The corrective measures may comprise modifying one of the parameters either at the capture or display or by recoding the 3D video stream. A parameter at the capture side may be modified by displaying a message to the user of the capture equipment as indicated at 550. Such a message could, for example, encourage a user to move back from the camera. At 560 a determination is made as to whether issue has been addressed. If not, then further action is taken at 550, if so, the process returns to issue detection at 510.

In the following we describe what issues can be detected and how. Here we consider the sender to have a stereo camera and the receiver a stereo display.

### Steps in Case of a Stereo Camera

1. On the receiving side, determine display parameters, such as display size or distance of the viewer from the screen. Additionally, estimate all limit values (such as minimum and maximum screen parallax P_{min□}, P_{max□}), where the limit values are defined such that comfortable 3D viewing can be expected (see further details in the sub-sections below). Send all receiver-specific values to the issue detector.

Where the issue detector is at sender side:
Convert to the sender input limits d_{min□} and d_{max□} using eq. 6 (this requires knowledge of the magnification factor S_{M}, i.e. the ratio of display width and sensor width).
Determine disparities in the 3D video (that is supposed to be sent to the receiver) and check if the limits d_{min□} and/or d_{max□} are violated

Where the issue detector is at receiver side:
Determine parallax in the 3D video (that was received from the sender) and check if the limits P_{min□} and/or P_{max□} are violated
3D enhancer (sender side, if any) f an issue is detected, activate the associated action

Where a 3D enhancer is at the receiver side:
If an issue is detected, activate the associated action.

Further details of issues and incompatibilities are given below. An indication of when the issue can be detected is given in parenthesis. “Live check” means that it's better to detect the issue in real-time, for example either during a video conference or during a calibration procedure.

### Maximum (Positive) Disparity (Live Check)

From equation (4) and FIG. 1, we can see that the maximum positive disparity that a human with inter-ocular distance of to can handle without diverging is

Pₘₐₓ=tₑ. (6)

The disparity values for different objects can be determined from the 3D video, if this exceeds the thresholds of P>P_{max□} or equivalently d>d_{max□}, then examples of appropriate actions that may be triggered are given below.

If the maximum positive disparity exceeds a threshold, then at the sender side: we can decrease (if we can) the sensor shift or baseline (either automatically or by a human operator) or to move the camera (or change the scene) to avoid objects that are too far from the camera (since

$${P}_{max} \leq {t}_{e} ( 1 - \frac{{Z}_{D}}{{Z}_{far}} ) )$$

(most likely achieved by human interaction). In case of human interaction, the system can display a warning message to the user and possibly highlight the area of the image where the maximum disparity threshold is exceeded (i.e. the object that causes the issue).

At the receiver side, if the maximum positive disparity exceeds a threshold, then it is possible to adjust the image shifting. This may be automatic: the shift s will be

$$s = {W}_{D}^{px} \frac{max ( P ) - {t}_{e}}{{W}_{D}}$$

pixels. This additional shift may then be integrated in all the parallax thresholds.

If the issue is not solved, the sender or receiver may fall-back to 2D mode.

### Minimum (Negative) Disparity (Live Check)

The limit of minimum negative disparity can be specified in allowed differences of vergence angles, Δαₜₒₜₐₗ. Using the common definition (with reference to FIG. 2)

$$\frac{α}{2} = β = {tan}^{- 1} ( \frac{\frac{{t}_{e}}{2}}{{Z}_{p}} ) • .$$

Because vergence angles are sufficiently small, the inverse tangent function can be approximated to a linear function. We can define the following approximations for two different kinds of vergence ranges, one for the viewer space in front of the display and one for the screen space behind the display:

$$\begin{matrix}{Δβ}_{viewer} = {β}_{{Z}_{near}} - {β}_{{Z}_{p}} \approx \frac{{t}_{e}}{2} ( \frac{1}{{Z}_{near}} - \frac{1}{Z} ) & ( 7 ) \\ {Δβ}_{screen} = {β}_{{Z}_{p}} - {β}_{{Z}_{far}} \approx \frac{{t}_{e}}{2} ( \frac{1}{Z} - \frac{1}{{Z}_{far}} ) & ( 8 )\end{matrix}$$

The total difference of vergence angles is:

$${Δα}_{total} = 2 ( {Δβ}_{viewer} + {Δβ}_{screen} ) \approx {t}_{e} ( \frac{1}{{Z}_{near}} - \frac{1}{{Z}_{far}} )$$

This value is set to a specific value such as 0.02 rad.

From eq. 4, 7 and 8 one can deduce the minimum limit of observed disparity P_{min□}:

Δₚ=Pₘₐₓ−Pₘᵢₙ=Z_{D}Δαₜₒₜₐₗ (9)

Pₘᵢₙ=tₑ−Z_{D}Δαₜₒₜₐₗ (10)

The human factors literature provides a number of heuristic figures and rules for choosing an appropriate vergence range. Examples of accepted values:
tₑ=0.065 m based on statistics
Z_{D}=1.67*W_{D} or Z_{D}=1.56*D_{D} where D_{D} is the screen diagonal size (in meter) of a 1080p 3D TV (which is the optimal viewing distance)
Δαₜₒₜₐₗ=0.02 rad

Note: The system will be improved if those values can be estimated from a calibration procedure (or by other means) instead of using statistical values, and transmitted to the issue detector in order to refine the limits (P_{min□}, P_{max□}, etc.).

Associated actions (triggered if P<P_{min□} or equivalently d<d_{min□}):

At the sender side: ask the user to move the camera (calibration configuration) or the object (real-tire checking)

At the receiver side: ask the user to move away from the screen (for instance, 50 cm backward) As long as the issue is not solved, the sender or receiver may fall-back to 2D mode.

### Framing Issue (Live Check)

A framing issue can be identified if any object close to the left and right boundaries appears only in one view. This issue is more likely to disturb the viewer if the object has significant negative disparity and is much more pronounced at the left and right screen borders, as illustrated in FIG. 6.

FIG. 6 illustrates the stereoscopic viewing process, with x being horizontal position and z distance from the viewer. Z_{D} indicates the distance between display 620 and viewer, and W_{D} indicates the screen width. Zₘᵢₙ and Zₘₐₓ indicate the comfortable range for objects to be displayed (so as to avoid excessive problems with accommodation-vergence conflicts). Each eye 610a, 610b has an associated field of view, indicated by a respective triangle 640a, 640b. The field of view for an eye 610 is determined by the position of the eye 610 and the display 620. If an object is displayed that is supposed to appear in an area where the fields of view 640a and 640b are not overlapping, it is seen by only one eye, which leads to an uncomfortable viewing experience. Areas of FIG. 6 that fall within only one of the fields of view 640a, 640b are indicated by “framing issues”. The areas within FIG. 6 represent volumes of the 3D display volume. In the 3D volume each field of view 640a, 640b would have a cone or a pyramid shape.

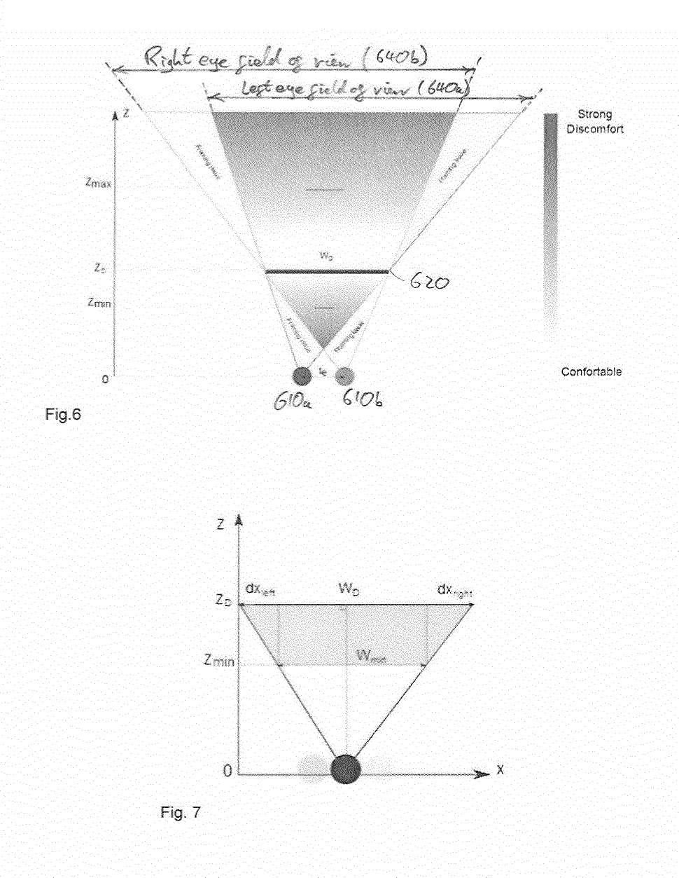

FIG. 7 illustrates an approximation of the viewing setup in FIG. 6. Here dX_{left} and dX_{right} indicate the horizontal (left and right) distances from the screen boundary where framing issues are potentially present.

A framing issue can be identified by detecting disparities (between left and right image) at the screen boundaries, i.e. in the ranges

x∈[0,dX_{left}] and x∈[W_{D}−dX_{right},W_{D}]

using the approximation of the viewing setup according to FIG. 7. Using basic geometry the values of dX_{left} and dX_{right} are found to be:

$${dX}_{left} = {dX}_{right} = \frac{{W}_{D}^{px}}{2} - \frac{{Z}_{min} {w}_{D}^{px}}{{Z}_{D}} \qquad ( 11 )$$

We may then define the maximum negative disparity authorized in the two extreme ranges:

$${Z}_{min ( x )} = {Z}_{D} - \frac{x ( {Z}_{D} - {Z}_{min •} )}{{dX}_{left}} \\ for x ∈ [ 0 , {dX}_{left} ] and \\ {Z}_{min ( x )} = {Z}_{min} - \frac{( {W}_{D}^{px} - x ) ( {Z}_{D} - {Z}_{min} • )}{{dX}_{right}} \\ for x ∈ [ {W}_{D}^{px} - {dX}_{right} , {W}_{D}^{px} ] , \\ {Z}_{min ( x )} = {Z}_{min} • \\ for x ∈ [ {dX}_{left} , {W}_{D}^{px} - {dX}_{right} ] \qquad ( 12 )$$

This limit on the observed depth can then be converted to a limit on the minimum parallax, Pₘᵢₙ₍ₓ₎, using Eq. 4:

$${P}_{min ( x )} = {t}_{e} ( 1 - \frac{{Z}_{D}}{{Z}_{min ( x )}} - {ɛ}_{f} ) ,$$

where ε is a small constant that models approximations errors (typically ε_{f}=10⁻³).

To address an identified framing issue, the sender may adapt the sensor shift (h) until all clipped foreground objects move into the screen space (positive disparity) (this can be done either automatically or with human interaction). A further way to avoid stereoscopic framing conflicts is to introduce a so-called floating window. A virtual image window that is shifted closer to the viewer than the screen is created electronically by adding horizontally displaced stripes to the image boundary. Thus, the viewer gets the illusion to look through this window on the screen and framing conflicts with the real screen borders are reduced. The appropriate size of the framing window can be calculated from eq. 10.

Associated actions, that are triggered if P(x)<Pₘᵢₙ₍ₓ₎, or equivalently if d(x)<dₘᵢₙ₍ₓ₎), are:

at the sender, ask the user to move the object that is triggering the detector, or turn the camera, so that the offending object is closer to the vertical centre line of the screen;
at the receiver, add a floating window adapted to the receiver's conditions.

If the issue is not solved, the sender or receiver may fall-back to 2D mode.

### Estimation of the Scale (Calibration)

As mentioned above, there can be a disparity between the actual depth and the apparent depth of a scene, giving the appearance of a puppet theater. This can be detected by defining a limit to a scaling ration using equations 3 and 4. For instance, by defining the following:

$${S}_{min} < max ( \frac{Z}{{Z}_{p}} ) < {S}_{max} \qquad ( 13 )$$

and triggering the alarm when the maximum measured value is outside this range [Sₘᵢₙ,Sₘₐₓ]. Here, Z indicates the distance of the object from the camera, and Zₚ indicates the perceived depth when viewing the displayed 3D scene on the target display.

It should be noted that computing Z/Zₚ requires the knowledge of several parameters (i.e. focal length, camera baseline, sensor shift and target screen size are required to compute Z and Zₚ in case of the stereo camera case, and Zₙₑₐᵣ and Z_{far} are required to compute Z in case a depth camera is used). These parameters may be obtained in a calibration procedure at the time when the capture and display systems are initially connected.

If the scale parameter S falls outside the threshold range, associated actions are: at the sender, increase or decrease the camera baseline or the zoom (focal length); at the receiver: instruct the viewer to come closer to the screen.

As long as the issue is not solved, the sender or receiver may fall-back to 2D mode.

### Chromatic Differences (Once, Sender Only, Stereo Camera Only)

The purpose here is to check if the two images have significantly different colors. If this is the case the 3D effect will be suboptimal. One way to detect chromatic differences is to calculate two color histograms (one for each of the left and right images) and to check if they are similar within a certain range (some difference is expected due to the differences in the views). If the histograms are different beyond a certain range, then the calculated difference is used to estimate the colour shift.

If a chromatic difference is detected, associated actions to address this are: at the sender: recalibrate the cameras; or perform a histogram shift using the estimated colour shift at the receiver: display a warning or just show one view (i.e. fall-back to 2D mode)

### Geometric Distortions (Once, Sender Only, Stereo Camera Only)

An example of geometric distortion is where the two views are vertically misaligned. One way to check for geometric distortion is to use features matched between views and coordinate these to robustly estimate the fundamental matrix for the two cameras and check that each has no rotation and no vertical translation.

One can also compute the closest homography from the fundamental matrix to rectify the second image if the sender cannot adjust its camera setup.

If a geometric distortion is identified, then appropriate actions are:
at the sender: calibrate the cameras; or apply image correction to one view to align it with the other (using the homography approximation); or issue a message to the user informing them that a geometric distortion has been identified and instructing them to calibrate the system. Alternatively, the vertical disparity mismatch could be automatically detected by shifting one and/or the other captured view vertically, or synthesizing a virtual view for one or the other view such that the vertical disparity is minimized or eliminated.
at the receiver: display a warning; just show one view; or apply the vertical shift to one view to vertically align both views,

### Temporal Synchronization (Live Check, Stereo Camera Only)

The two views displayed by the stereo display can become out of sync or out of time with each other. This is very detrimental to the 3D effect. Thus it is important to check if the two views are synchronized. There are different metrics that detect this issue, for instance by comparing the timestamps of the two video feeds.

This matter may be corrected at either the sender or receiver by aligning the temporally mismatched videos by for example delaying one of the videos.

### Variations for a Depth Camera Plus Image Camera

If the camera provides directly or indirectly a depth map (depth map camera) instead of two images streams (stereo camera), the warning can be based on the depth map. Moreover, one can send an advised baseline to be rendered.

An objective of this is to assist the Depth/image Based Rendering (DIBR) at the receiver to generate a good new view by suggesting to it the best baseline and sensor shift according to the capture camera and the receiver's screen. Further, this may assist the calibration of the camera or the set-up of the scene being captured if the DIBR cannot generate an optimal additional view,

This is done by
Defining the limits on the disparities Pₘₐₓ, P_{min□} (to avoid divergence and convergence issues).
Converting the two limits to limits on the sender depth camera Zₘᵢₙ and Zₘₐₓ using equations 3 and 6.

$${Z}_{min} = \frac{{bf}_{d}}{s - \frac{{P}_{min}}{{S}_{M}}} and {Z}_{max} = \frac{{bf}_{d}}{s - \frac{{P}_{max}}{{S}_{M}}} \qquad ( 14 )$$

Checking if the depth map values are in the range [Zₘᵢₙ,Z_{max□}](depth budget, see FIG. 6)
Check other issues like framing issues (and make [Zₘᵢₙ₍ₓ₎,Zₘₐₓ₍ₓ₎] from eq. 14
Check if there is missing depth information (and where)
If some values are outside the range:
   Ask the user to change the camera viewpoint, to move closer (issue with Zₘₐₓ) to the scene or to move away the front object (issue with Zₘᵢₙ).
   Show on the sender screen where the issue is located
   Directly mask the problematic area (set depth to a smaller value or zero and/or erase the associated texture) or
   Propose the receiver's DIBR to decrease the baseline
If some depth values are missing, inform the sender where those areas are located and ask to solve it (move the camera or move away the object).

If some values are outside the range: directly mask the problematic area (set depth to a smaller value or zero and/or erase the associated texture); or adjust the baseline and sensor shift to get all depth Z inside [Zₘᵢₙ₍ₓ₎,Zₘₐₓ₍ₓ₎]:

### Example of Baseline Adaptation

If max(Z)>Zₘₐₓ and min(Z)<Zₘᵢₙ then divide the baseline b by some value (such as 2).

If max(Z)>Zₘₐₓ then increase the sensor shift s (and/or decrease the baseline b)

If min(Z)<Zₘᵢₙ then decrease the sensor shift s (and/or decrease the baseline b)

Many Receivers with 3D Screens

In this case, we consider one sender and many receivers, each with at least one 3D display, which is a typical case in a multiparty video conferencing scenario. Here we need to help the sender to set up its camera or scene in order to improve the 3D experience at all of the receivers. One way to achieve this goal is to find appropriate values for [dₘᵢₙ, dₘₐₓ] (stereo camera) or [Zₘᵢₙ,Zₘₐₓ] (depth camera).

### Solution for Finding the Common Best Viewing Conditions (Stereo Camera):

Estimate all limits for all i=1 . . . N screens (N=number of screens): Pⁱₘᵢₙ and Pⁱₘₐₓ, by acquiring display parameters from the receiving systems. Display parameters may comprise width and viewing distances, for instance 55′ TV screens and 22′ computer screens, an approximation of the viewing distance derivable from the type of screen. An alternative would be to indicate a range of supported screen sizes during session setup, e.g. by means of SDP signaling. Another alternative would be that the receiver indicates its screen size to the sending system.

Convert to the sender disparity scale [dₘᵢₙ,dₘₐₓ]

Convert to limits on the sender camera [dⁱₘᵢₙ, dⁱₘₐₓ] using eq. 6

Get the common limits and solve for instance dₘᵢₙ=maxᵢ (dₘᵢₙⁱ) and dₘₐₓ=minᵢ(dₘₐₓⁱ)

Check the consistency: dₘₐₓ≧dₘᵢₙ

Use dₘᵢₙ and dₘₐₓ for all issue detection

Another way is to advise to the receivers the best image shift s*, for instance using the method described in PCT/EP2011/069942. Then using eq. 6 with s to obtain [dⁱₘᵢₙ, dⁱₘₐₓ].

### Solution for Finding the Common Best Viewing Conditions (in Case of a Depth Camera):

Estimate al limits for all i=1 . . . N screens (N=number of screens): Pⁱₘᵢₙ and Pⁱₘₐₓ, by asking the receiver system or to use a subset of “supported” screen width and viewing distances, for instance 55′ TV screens and 22′ computer screens. An alternative would be to indicate a range of supported screen sizes during session setup, e.g. by means of SDP signaling. Another alternative would be that the receiver indicates its screen size to the sender.

Convert to the sender depth limits [Zₘᵢₙ,Zₘₐₓ]

Convert to limits on the sender camera [Zₘᵢₙⁱ,Zₘₐₓⁱ] using eq. 14.

Get the common limits and solve for instance

Zₘᵢₙ−maxᵢ(Zₘᵢₙⁱ) and Zₘₐₓ−minᵢ(Zₘₐₓⁱ)

Check the consistency: Zₘₐₓ≧Zₘᵢₙ. Use Zₘᵢₙ and Zₘₐₓ for subsequent issue detection.

Another way is to advise to the receivers' DIBRs the best baseline b* and image shift s* to render, for instance using the method described in PCT/EP2011/069942. Then using eq. 13 with those two optimal values (b=b* and s=s*) to obtain [Zⁱₘᵢₙ,Zⁱₘₐₓ]. If the DIBR cannot be controlled, one can also rescale the depth map (3D enhancer @receiver side) such that for instance the linear relation

$${Z}^{′} = {α}^{i} ( Z - {Z}_{min}^{i} ) + {t}^{i} , with {α}^{i} = {b}^{*} and {t}^{i} = \frac{{b}^{*} f}{{s}^{*}} .$$

And using eq. 14 with the new rescaled depth map Z′ to compute [Zⁱₘᵢₙ, Zⁱₘₐₓ]

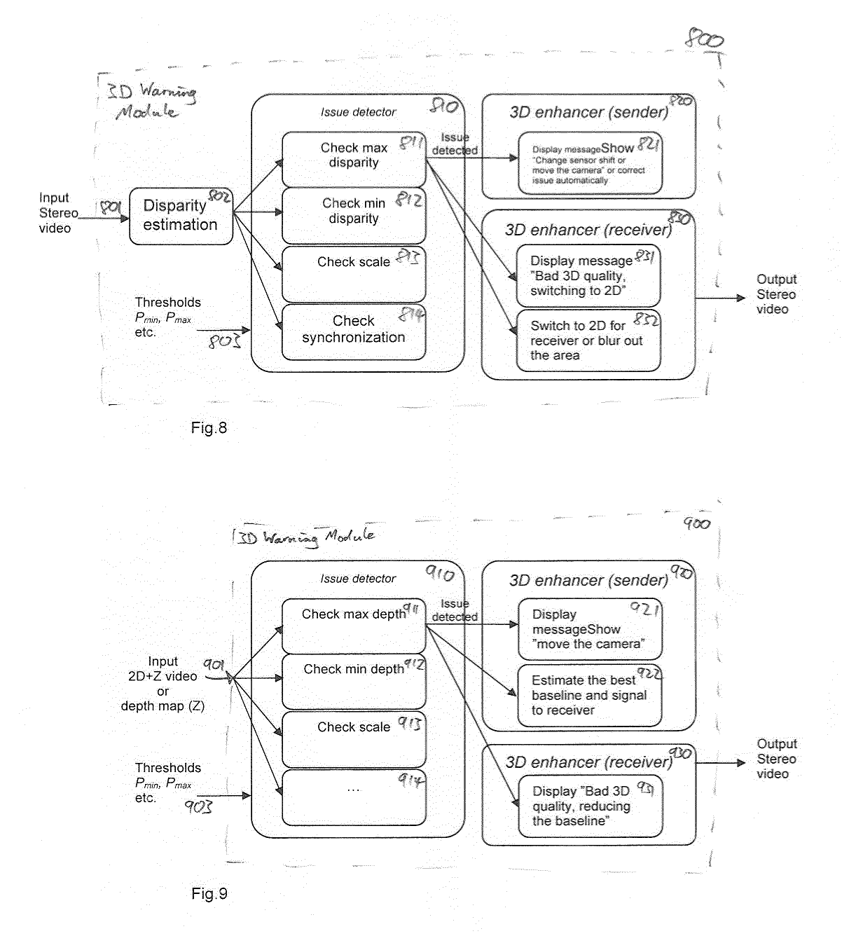

FIG. 8 illustrates a 3D warning module 800 as applied to a stereo camera. The 3D warning module 800 shown comprises an issue detector 810 which is able to send instructions to at least one 3D enhancer 820, 830. Two 3D enhancers are shown, one 820 for the sender, and one 830 for the receiver. In this embodiment, the 30 enhancers 820, 830 are at the same location as the issue detector 810, but the transmitting and receiving end points may each have a 3D enhancer.

At 801 the 3D warning module 800 receives stereo video for checking. At 802 a disparity estimation process is run to build a disparity map for the received video. Such a disparity map may be generated by feature detection and matching, an Optical Flow or any vision-based disparity estimation algorithm in order to get a set of disparities from the stereo images. At 803 the issue detector 810 receives defined limits (Pₘᵢₙ, Pₘₐₓ, etc.) from the sender and receiver(s) apparatus.

The issue detector 810 then proceeds to check for at least one of the above described issues or incompatibilities. In the figure such checking comprises: determining 811 maximum disparity is within range; determining 812 minimum disparity is within range; checking 813 scale; and checking 814 view synchronization.

Disparity estimation module 802 is not essential to the 3D warning module 800. Certain checks, such as view synchronization 814 may be performed before or in the absence of disparity estimation 802.

If an issue or incompatibility is detected by issue detector 810, then a notification is sent to the 3D enhancer. The notification may be sent over a communication network if the issue detector 810 and the 3D enhancer 820, 830 are at different locations.

After receiving the notification, the 3D enhancer may take appropriate steps to correct the issue or incompatibility. For example, at a sender-side 3D enhancer 820 the area of the scene that has the issue may be highlighted in a user interface for the user of the sending apparatus. Alternatively the user interface for the user of the sending apparatus may display a message such as “An object is too close/far, adjust the camera's sensor shift or move the object.”

By way of further example, for a receiver-side 3D enhancer 830, the user interface for the user of the receiving apparatus may display a message “The 3D experience is not optimal, the sender has been asked to adjust the camera.” Alternatively, the 3D enhancer 830 may instruct the receiver side apparatus to display only a 2D stream.

FIG. 9 illustrates a 3D warning module 900 as applied to a depth plus image camera. The 3D warning module 900 shown comprises an issue detector 910 which is able to send instructions to at least one 3D enhancer 920, 930. Two 3D enhancers are shown, one 920 for the sender, and one 930 for the receiver. In this embodiment, the 3D enhancers 920, 930 are at the same location as the issue detector 910, but the transmitting and receiving end points may each have a 3D enhancer.

At 901 the 3D warning module 900 receives stereo video for checking. At 903 the issue detector 910 receives defined limits (Pₘᵢₙ, Pₘₐₓ, etc.) from the sender and receiver(s) apparatus and converts these to depth limits [Zₘᵢₙ,Zₘₐₓ] as described above.

The issue detector 910 then proceeds to check for at least one of the above described issues or incompatibilities. In the figure such checking comprises: determining 911 maximum depth is within range; determining 912 minimum depth is within range; and checking 913 scale. Further checks 914 may be made.

If an issue or incompatibility is detected by issue detector 910, then a notification is sent to the 3D enhancer. The notification may be sent over a communication network if the issue detector 910 and the 3D enhancer 920, 930 are at different locations.

After receiving the notification, the 3D enhancer may take appropriate steps to correct the issue or incompatibility. For example, at a sender-side 3D enhancer 920 a user interface for the user of the sending apparatus may display a message such as “Move the camera” 921. Alternatively, the 3D enhancer may estimate 922 the best baseline and signal this to the receiver.

By way of further example, for a receiver-side 3D enhancer 930, the user interface for the user of the receiving apparatus may display a message “Poor 3D quality, switching to 2D” and switch to a 2D mode.

There are a number of things that the sender may do in order to improve the receiving user's 3D experience.

For a stereo camera:
changing the sensor shift (often) and zoom (often) (may be done either automatically or with human intervention);
calibrating the camera: to eliminate or at least reduce to a minimum colour/geometric distortions. (This is less convenient and may be done during maintenance of the equipment or during a setup procedure) (again, this may be done either automatically or with human intervention);
changing the camera baseline (this would be done rarely) (likely done with human intervention, but may also be done automatically);
moving the camera (likely done with human intervention, but may also be done automatically); and/or
moving the scene (likely done with human intervention).

For a depth plus image camera:
changing depth sensor settings such as depth range;
moving the camera (likely done with human intervention);
moving the scene (likely done with human intervention); and/or
scaling the depth map and adjusting the convergence depth (may be done automatically).

There are a number of things that the receiver may do in order to improve the receiving user's 3D experience.

For a stereo screen without DIBR:
moving the viewer position with respect to the screen;
shift the two images (not often available) (may be done automatically); changing the color; and/or
correct misalignment.

For a stereo screen with DIBR:
moving viewer position with respect to the screen;
adapting the baseline and the image shift for synthesizing the novel view (may be done automatically);
changing the color; and/or
correct misalignment.

Both display parameters and camera parameters may be received by the 3D warning module. These are used to detect issues or incompatibilities with the 3D setup.

### 3D Camera Parameters:

sensor width (Wₛ) or diagonal and horizontal resolution (Wₛ^{px}),
focal length(s),
sensor shift,
baseline,
encoding parameters n, Zₙₑₐᵣ and Z_{far}.

### Display Parameters:

screen width (W_{d}) or diagonal and horizontal resolution (W_{d}^{px})
image shift (s),
characteristics of the DIBR synthesizer (such as: baseline (b), image shift s, focal length.)
viewer position (Z_{D}),
interocular distance (tₛ),
number of view synthesized,
number of viewers and corresponding characteristics (Z_{D},tₑ)

The more parameters the 3D warning module has, the more issues that can be identified and the more reliable the detection will be. Some variables or parameters may be estimated from statistical values, or predetermined approximations if they are not signaled.

The 3D warning module described herein can be used as a calibration step at the beginning of a 3D video conference but may also be used during the conference. At the beginning of the conference (or shortly before), the transmitting user adjusts the camera and the scene in order to provide an optimal 3D experience to the receivers.

Where each receiver is also a sender, every node may perform this calibration process.

During the calibration process the warning system helps the sender to adjust the 3D camera settings (sensor shift for instance, or 3D calibration) in order to improve the 3D experience at the receiver side. For example the sender may receive the screen widths of all receivers at the beginning of the conference or during a setup phase. An issue detector in the 3D warning module estimates the limits (P_{min□}, P_{max□}, etc.) of the 3D setup for the 3D display at each receiver. It may also identify optimum system parameters such as sensor shift and scene distance. The issue detector detects if there is any issue and communicates the detected issues to the 3D enhancer, which may also be a part of the 3D warning module. If an issue or incompatibility is detected, the 3D enhancer asks the sender to fix it (adjust the camera or the scene, etc.)

There is also an automatic warning mode that may be implemented. In this mode the 3D warning module runs in parallel to the video conference and makes determinations about the 3D experience at at least one the receiver side display apparatus, the determination made during the display of the 3D video. For example: an object in the 3D camera field of view comes too close to the 3D camera and breaks the maximum disparity or depth limit. A warning is then displayed at the sender side, for instance “Object too close to the camera, please move back”.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfill the functions of several units recited in the claims. Any reference signs in the claims shall not be construed so as to limit their scope

It will be apparent to the skilled person that the exact order and content of the actions carried out in the method described herein may be altered according to the requirements of a particular set of execution parameters, such as speed of encoding, accuracy of detection, resolution of video sources, type of compression standards in use, and the like. Accordingly, the order in which actions are described and/or claimed is not to be construed as a strict limitation on order in which actions are to be performed.

The 3D video can comprise stereo video, multiview video, texture plus depth, multiview texture plus depth, layered depth video, depth enhanced stereo or any other related format. The system may be implemented in a TV or a 3D video conference system or a desktop computer, laptop, tablet, mobile phone or in a camera.

1. A 3D video warning module comprising:
an input for receiving:
capture information from a 3D capture device, and
display information from at least one 3D display device, wherein the 3D display device is for displaying 3D video captured by the 3D capture device;
a processor for analyzing the capture information and the display information, the processor arranged to identify at least one issue; and
an output for sending a notification of the issue to at least one of the 3D capture device and the 3D display device.

2. The 3D video warning module of claim 1, wherein the notification of the issue sent to the 3D capture device comprises modified capture parameters in order to resolve the issue.

3. The 3D video warning module of claim 1, wherein the notification sent to the 3D display device is a warning of an issue.

4. The 3D video warning module of claim 1, wherein: the input is also for receiving 3D video captured by the 3D capture device; and the processor is for analyzing the 3D video.

5. The 3D video warning module of claim 1, wherein the capture information comprises at least one of: sensor width, sensor resolution, focal length, sensor shift, baseline, encoding parameters, and depth range.

6. The 3D video warning module of claim 1, wherein the display information comprises at least one of: screen width, screen resolution, image shift, baseline, focal length, viewer position, inter-ocular distance, and number of viewers.

7. The 3D video warning system of claim 1, wherein the identified at least one issue comprises at least one of:
maximum disparity threshold exceeded;
minimum disparity threshold exceeded;
a framing issue;
incorrect scale;
chromatic difference;
geometric distortion; and/or
lack of synchronization.

8. The 3D video warning module of claim 1, wherein the 3D video warning module is located at:
a location for the transmission of 3D video;
a location for the distribution of 3D video;
a location for the reception of 3D video; or
a location for the reception and transmission of 3D video.

9. A method for detecting an issue in a 3D video system, the method comprising:
receiving capture information from a 3D capture device, and display information from at least one 3D display device, wherein the 3D display device is arranged to display 3D video captured by the 3D capture device;
analyzing the capture information and the display information and determining if these cause at least one issue; and
if an issue is detected, sending a notification of the issue to at least one of the 3D capture device and the 3D display device.

10. The method of claim 9, wherein the notification of the issue sent to the 3D capture device comprises modified capture parameters in order to resolve the issue.

11. The method of claim 9, wherein the notification sent to the 3D display device is a warning of an issue.

12. The method of claim 9, wherein the 3D video is also analyzed for the detection of issues.

13. The method of claim 9, wherein the capture information comprises at least one of: sensor width, sensor resolution, focal length, sensor shift, baseline, encoding parameters, and depth range.

14. The method of claim 9, wherein the display information comprises at least one of: screen width, screen resolution, image shift, baseline, focal length, viewer position, inter-ocular distance, and number of viewers.

15. The method of claim 9, wherein the identified at least one issue comprises at least one of:
maximum disparity threshold exceeded;
minimum disparity threshold exceeded;
a framing issue;
incorrect scale;
chromatic difference;
geometric distortion; and/or
lack of synchronization.

16. A non-transitory computer-readable medium, having instructions stored therein, which, when executed by processor, causes said processor to carry out the method of claim 9.
